(19) United States
(12) Patent Application Publication
(10) Pub. No.: US 2006/0112996 A1
(43) Pub. Date: Jun. 1, 2006

(54) Treatment of pipes

(76) Inventor: Antony G. Poole, Hampshire (GB)

Correspondence Address: STITES & HARBISON PLLC, 1199 NORTH FAIRFAX STREET, SUITE 900, ALEXANDRIA, VA, 22314, US

(21) Appl. No.: 10/539,404

(22) PCT Filed: Sep. 3, 2003
(86) PCT No.: PCT/GB03/03833

§ 371 Date: Jun. 17, 2005

(30) Foreign Application Priority Data
Sep. 3, 2002 (GB) 0220462.6

(51) Int. Cl. F16L 55/18

(52) U.S. Cl. 138/97; 138/98

(57) ABSTRACT

A method and apparatus for treating the interior of a pipe having one gap or discontinuity or a plurality thereof is presented. Gaps or discontinuities may be of the form of a joint between two discrete sections of pipe, a redundant fluid passage communicating with the main pipe, a ferrule intrusion (15) such as a service connection or plug connection, or they may form due to deterioration of the pipe over a period of time. A filling material or sealing material (21) is applied to the gap or discontinuity, once the gap or discontinuity has been located, and this may be subsequently sprayed with a lining material (34) to form a continuous lining for the pipe. Means are also provided to exclude air from the region of the gap or discontinuity to be filled, thereby aiding the creation of a substantially smooth surface by the exclusion of air bubbles. The method described can also provide a substantially continuous surface around an intrusion into the pipe, thereby eliminating a potential “spray shadow” when the lining material (34) is subsequently sprayed on to the interior surface of the pipe.

### BACKGROUND OF THE INVENTION

1. Field of the Invention

The present invention relates to a method for treating or lining the interior of a pipe having one gap or discontinuity or a plurality thereof and to apparatus for performing such a method.

2. Description of Related Art

Pipelines for transporting fluids such as water, oil, gas and sewage are well known. Typically, such pipelines extend for a long distance and comprise a plurality of discrete pipe sections that are coupled together. FIG. 1 shows a prior art arrangement where a first pipe section 1 and second pipe section 3 are coupled together by a spigot and socket joint 5. To prevent egress of fluid from the joint between the two pipe sections 1 and 3, an annular seal 7 is provided which seals the interior surface of the enlarged section 9 of the second pipe section 3 against the exterior surface of the first pipe section 1.

Typically, such pipelines are buried underground. Over a period of time fluid leaks can develop. For example, the pipeline may crack (due to ground movements) or may corrode. When the pipeline comprises a plurality of coupled sections, fluid leaks at the spigot and socket couplings 5 can develop, due to ground movement and deterioration of the annular seals 7. It is known to line pipelines with a sealing material in order to prevent fluid leakage. A lining may be in the form of a pre-formed flexible membrane which is passed along the interior of the pipeline and fixed in position, or may be applied by spraying lining material onto the interior surface of the pipeline. Such linings may be formed when the pipeline is initially laid, or may be provided after a period of use, when the pipeline itself or the spigot and socket couplings 5 begin to deteriorate.

FIG. 2 shows a view of part of the pipeline of FIG. 1 to which a lining 11 has been applied by a spraying method. The lining 11 has not performed the desired function of providing a fluid-tight path within the interior of the pipeline because the material of the lining 11 has been unable to bridge the gap 13 between the first and section pipe sections 1 and 3. When such a situation arises, the lining process has been unsuccessful and any fluid leakage that was occurring at the spigot and socket joint 5 prior to lining the pipeline will continue.

The spigot and socket type joint is commonly employed for forming underground pipelines because it provides flexibility for ground movement, angular deflections and allows some expansion and contraction of the sections of the pipeline.

It is also sometimes desired to seal off a redundant fluid passage communicating with the main pipeline. Generally, a conventional lining method will not be able to successfully bridge such a fluid passage, and a lining operation carried out in the conventional manner will therefore fail.

Similarly, conventional lining methods will not be suitable for sections of pipeline containing one or more ferrule intrusions (as shown in FIG. 3) such as service connections or plug connections.

It is known to seal a joint or crack in sewage pipelines by injecting a water-based fluid through an inflated bladder or expanded “packer”. The bladder or packer is expanded so that it presses against each joint or crack to test for leakage at the joint or crack. Sealing material in gel form is then pumped through the joint or crack and into the void existing there where it mixes with the substrate to form a low strength flexible barrier membrane outside the sewer pipeline. Such a method will not work unless the joint or crack does in fact leak (so that fluid can pass from the interior of ihe pipeline to the exterior of the pipeline). This is because air (or other fluid) entrapped in the area of the joint or crack will prevent the sealing material properly passing into the joint or crack.

### BRIEF SUMMARY OF THE INVENTION

According to a first aspect of the present invention, there is provided a method of treating a pipe having at least one gap or discontinuity on the interior surface thereof, the method including applying filling material to the gap or discontinuity so as to provide a generally smooth interior surface of the pipe at the region of the gap or discontinuity.

The gap or discontinuity may arise as a result of the pipe cracking (particularly in sewer pipes), or may arise as a result of holes in the pipes formed by corrosion (in metal pipes). Additionally, the gap or discontinuity may be a redundant fluid passage or take-off from the main pipe, or a ferrule intrusion such as a service connection or plug connection.

The method of the first aspect of the present invention may further comprise spraying a lining material over the interior surface of the pipe to line the pipe, including the region of the gap or discontinuity.

By providing a filling material to the gap or discontinuity in the pipe a continuous, substantially smooth interior surface of the pipe may be formed. The gap as shown at 13 in FIG. 2 is bridged. This allows a subsequently applied lining material to be applied by a spraying method. Because the gap 13 between the pipe sections is reduced or eliminated, the spray coated lining will tend to bridge the coupling between the pipe sections (or other gap), thereby providing a fluid-tight conduit within the pipe.

The pipe sections may be coupled by a spigot and socket joint, although it should be understood that the invention is not limited to such a joint arrangement. The invention may be advantageous when applied to the coupling region where two pipe sections join, at which there is anything other than a completely smooth interior surface to the pipeline at the point of transition from one pipe section to another pipe section. The lining material may form a cross-linked molecular structure on the interior surface of the pipe. For example, the lining material may be a flexible polyurea.

Typically, a fluid seal is applied between the pipe sections. Such a fluid seal may be a conventional annular fluid seal as shown at 7 in FIGS. 1 and 2. The fluid seal will generally be applied prior to lining a pipeline, and prior to applying the filling material. Indeed, the seal may have been used in the pipe as the only measure for preventing fluid egress for a period of time, after which the seal becomes ineffective, at which time the filler material and spray lining according to the present invention are applied in order to restore integrity of the pipeline. Typically, the seal is located further from the centre of the pipe than the filler material, the filler material being formed at the interior of the pipe and the seal being formed between overlapping portions of adjacent pipe sections when, for example, a spigot and socket coupling is employed.

According to a further aspect of the present invention, there is provided a method of sealing a pipe having at least one gap or discontinuity on the interior surface thereof, the method including applying filling material to the gap or discontinuity, wherein the filling material also acts as a sealant The filling material and sealant used is preferentially a low-density polymer, although it will be appreciated that other materials could be used. It is also preferential for this filling material and sealant to set in approximately one minute and to mix in a ratio of 1:1.

According to a still further aspect of the present invention there is provided a method of sealing a pipe having at least one gap or discontinuity on the interior surface thereof, the method including applying filling material or sealing material to the gap or discontinuity, wherein the filling material or sealing material is forced at pressure through a small orifice, causing impinged mixing of the two materials. In such an operation, any residual mixed material would be ejected by a piston and acts as a seal.

According to another aspect of the present invention, there is provided a method of sealing a pipe having at least one gap or discontinuity on the interior surface thereof, the method including applying filling material or sealing material to the gap or discontinuity, wherein the filling material or sealing material is delivered by a triple piston arrangement in a short burst.

According to another aspect of the present invention, there is provided a method of sealing a pipe having at least one gap or discontinuity on the interior surface thereof, the method including means for the allowing the removal of air from the top of the joint area. The means for allowing the removal of air from the top of the joint area includes a vacuum port located in the surface of the packer, with the vacuum port constructed from a material able to absorb air but not liquid.

According to another aspect of the present invention, there is provided a method of sealing a pipe having at least one gap or discontinuity on the interior surface thereof, the method including means for allowing air or fluid within the gap to be sufficiently compressed to contain that air or fluid within the gap or discontinuity such that the filling material or sealant forms a smooth surface to the area. The control of the compression may involve the application of suitable inflation and/or reciprocating pressures.

According to another aspect of the present invention, there is provided a method of sealing a pipe having at least one gap or discontinuity on the interior surface thereof, the method including means for precisely locating the packer over each gap or discontinuity. The means for precisely locating the packer over each gap or discontinuity includes the use of a 12 mm diameter mini camera inserted in the top surface of the packer.

According to another aspect of the present invention, there is provided apparatus for sealing a pipe having at least one offset gap or discontinuity either radial or lateral on the interior surface thereof, including a packer with sufficient flexibility to allow for a generally smooth surface to be formed by application of filling material in the area of the gap or discontinuity. For example, there may be a step or corner in the pipe wall to which the filling material is applied.

According to a further aspect of the invention, there is provided a method of sealing a pipe having at least one gap or discontinuity on the interior surface thereof, the method including applying the filling material or sealing material by forming a cavity at the gap or discontinuity and supplying filling material or sealing material to the cavity. The cavity is preferably formed by use of an inflatable bladder which is inflated within the pipe.

According to a further aspect of the invention, there is provided a method of sealing a pipe having at least one gap or discontinuity on the interior surface thereof, the method including applying the filling material or sealing material to a pre joined or welded area of two pipes where a coating of the welded area is required to provide a continuous internal protective coating.

Further aspects of the invention are defined in the claims.

### BRIEF DESCRIPTION OF THE DRAWINGS

For a better understanding of the present invention, the method for sealing a pipe will now be described by way of example, with reference to the accompanying drawings, in which:

FIG. 1 shows a cross-section through a conventional pipe comprising two sections coupled by a spigot and socket joint, in accordance with the prior art;

FIG. 2 shows a partial view of the pipe of FIG. 1 to which a spray coated material has been applied unsuccessfully, in accordance with the prior art;

FIG. 3 shows a cross-section through a conventional pipe containing a ferrule intrusion such as a service connection or a plug connection, to which a spray coated material has been applied unsuccessfully, in accordance with the prior art;

FIG. 4 shows a pipeline to which filling material is being applied;

FIG. 5 shows a pipeline to which a filling material is being applied by an alternative method;

FIG. 6 shows the application of a lining material to the pipe of FIG. 4 or 5 by spraying;

FIG. 7 shows the pipe of FIG. 6 after completion of formation of the liner;

FIGS. 8A and 8B show a cross-section of a mixing arrangement used to deliver the filling or sealing material;

FIG. 9 shows a cross-section of a triple piston arrangement used to deliver the filling or sealing material;

FIG. 10 shows a cross-section of a pipeline and packer, including a vacuum port located in the surface of the packer;

FIG. 11 shows a cross-section of a pipeline and packer, including a camera;

FIG. 12 shows a cross-section of a pipeline and packer including an inflatable bladder located over a ferrule intrusion;

FIG. 13 shows the packer of FIG. 12, with the bladder inflated to seal around the ferrule intrusion;

FIG. 14 shows the application of sealing material to the pipe of FIG. 13 after the application of filling material around the ferrule intrusion; and

FIG. 15 shows the application of filling material to a gap in a pipe lining at the region of a weld.

In the drawings, like elements are generally designated with the same reference numeral.

### DETAILED DESCRIPTION OF THE EMBODIMENTS OF THE INVENTION

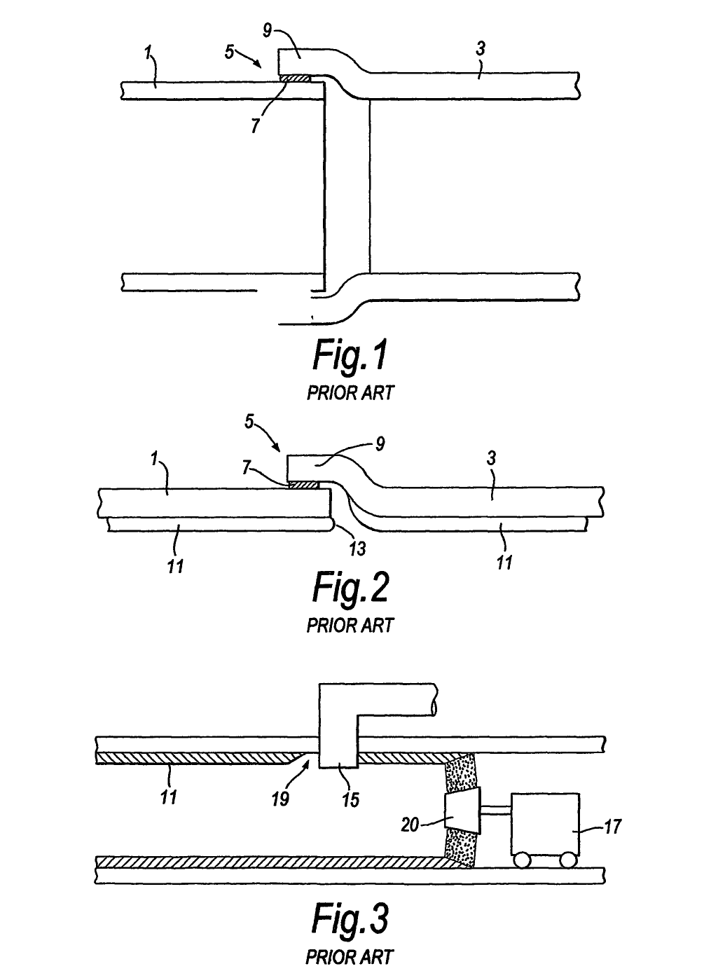

FIG. 1 shows a prior art arrangement where a first pipe section 1 and a second pipe section 3 are coupled together by a spigot and socket joint 5. To prevent egress of fluid from the joint between the two pipe sections 1 and 3, an annular seal 7 is provided with seals the interior surface of the enlarged section 9 of the second pipe section 3 against the exterior surface of the first pipe section 1.

FIG. 2 shows a view of part of the pipeline of FIG. 1 to which a lining 11 has been applied by a spraying method. This lining 11 has not performed the desired function of providing a fluid-tight path within the interior of the pipeline because the material of the lining 11 is unable to bridge the gap 13 between the first and second pipe sections 1 and 3. When such a situation arises, the lining process has been unsuccessful and any fluid leakage that was occurring at the spigot and socket joint 5 prior to lining the pipe will continue.

The invention is applicable to other types of pipe joints where an internal discontinuity is created. For example, the pipe sections may be coupled by a welded joint or are coupled by a bolted gland joint.

FIG. 3 shows a different prior art arrangement where the interior of a pipe contains a discontinuity such as a ferrule intrusion 15. When a lining 11 is applied to such a pipeline by a spraying method using a vehicle 17, the method fails to apply a constant thickness of material when negotiating the intrusion 15. This leaves an area 19 where the lining material 11 is not as thick with respect to the rest of the pipe, referred to herein as a “spray shadow”. This “spray shadow” is caused by the intrusion 15 deflecting the sprayed particles leaving a shadow of thin lining in the area 19 on the opposite side to the direction of movement of the spinning application cone 20.

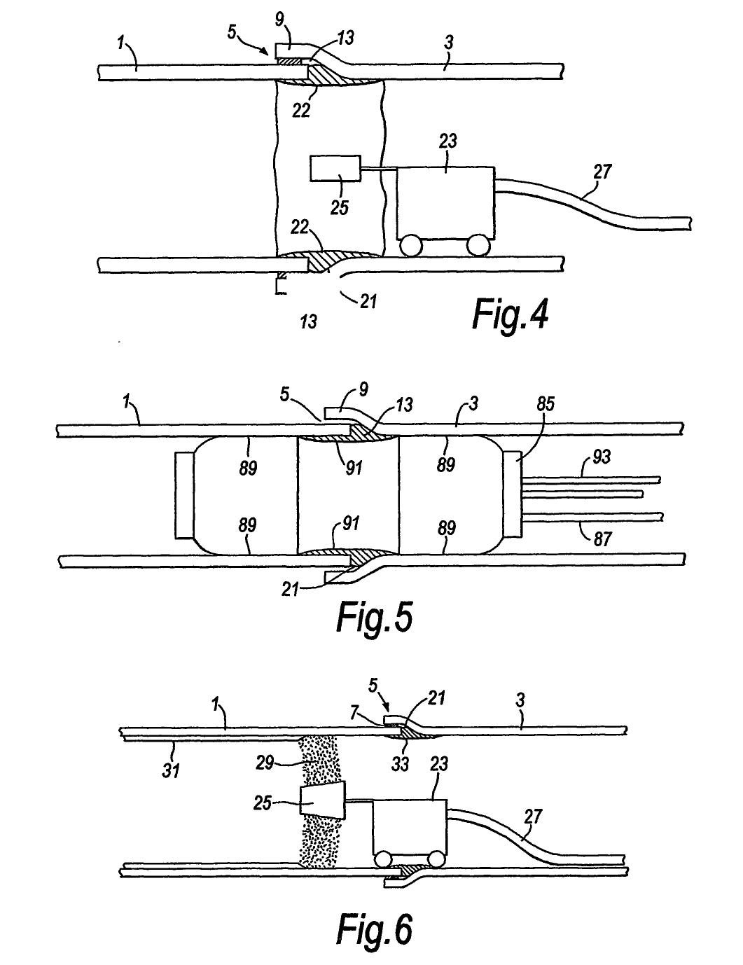

According to a first embodiment of the invention, a pipeline is formed by excavating a channel in the ground, in which a plurality of separate pipe sections are laid. FIG. 4 shows a first pipe section 1 and a second pipe section 3, although it will be appreciated by those skilled in the art that a pipeline will typically comprise a multiplicity of such sections. One end of each pipe section 3 has an enlarged diameter portion 9, into which the end of the adjacent pipe section 1 fits. This is the conventional spigot and socket joint. An annular seal 7 is provided between the pipe sections 1 and 3, and it is intended that this seal 7 will provide a fluid-tight joint.

The pipeline thus formed may carry, for example, water, oil, gas or other fluids for consumption by the recipients. The pipeline may alternatively carry sewage.

It may be desired to line the pipeline immediately after the pipeline has been laid in the ground, or after a period of time, when the integrity of the seals 7 have deteriorated so that fluid egress at the coupling 5 between the pipe sections tends to occur.

As discussed in relation to the prior art, a gap or discontinuity 13 exists at the region where the pipe sections 1 and 3 are coupled. In accordance with an aspect of the invention, as shown in FIGS. 4 and 5, a gap spanning material 21 is applied to the gap or discontinuity 13. The material 21 forms an interior surface 22 that bridges across the gap or discontinuity 13, providing a relatively smooth interior surface to the pipeline. In FIGS. 4 and 5, the surface of the material 21 is shown to be slightly proud of the interior surfaces of the pipe sections 1 and 3, where the material 21 is applied to the interior surface of the pipe sections 1 and 3 for a small distance either side of the gap or discontinuity 13. The material may be applied such that the interior surface 22 is flush with the interior surfaces of the pipe sections 1 and 3, or excess material 21 may be removed to provide a flush surface. Alternatively, the surface 22 may be allowed to remain slightly proud of the interior surfaces of the pipe sections 1 and 3 where this allows the successful subsequent application of a lining material. Further alternatively, the surface 22 may be allowed to remain slightly concave of the interior surfaces of the pipe sections 1 and 3 where this allows the successful subsequent application of a lining material.

As shown in FIG. 4, a filling material 21 may be applied by spraying the material 21 at the region where the gap or discontinuity 13 is present. For example, a remote controlled vehicle 23 may enter the pipeline at one end thereof, or at a special location provided for the insertion of such vehicles, after which the vehicle 23 moves to the appropriate locations within the pipeline. A spray head 25 sprays material 21 into the gap or discontinuity 13. The material may be supplied remotely through a pipeline 27, or the vehicle 23 may include a sufficient reservoir of material, in which case the pipeline 27 is unnecessary.

FIG. 5 shows an alternative method for applying gap spanning material 21 to the gap or discontinuity 13. An inflatable bladder 85 is moved, in a state of deflation, to the desired region of the pipeline, where the gap or discontinuity 13 exists. The bladder 85 is then inflated by applying fluid pressure via conduit 87. Generally, the bladder 85 is formed of flexible material. However, relatively rigid sections 89 are provided for location either side of the gap or discontinuity 13, defining a gap spanning material 21 application region 91 there between. When the bladder 85 is inflated, the relatively rigid sections 89 press against the interior surface of the pipeline. Gap spanning material 21 is then applied to the regions 91 by way of conduit 93. The relatively rigid sections 89 prevent the gap spanning material escaping from the region 91. The bladder 85 may remain in position after application of the gap spanning material in order to allow the material to cure, if necessary.

The bladder 85 may be initially inflated to a pressure of about 0.5 bar. The gap spanning material 21 is then applied to the region 91 and enters the gap or discontinuity 13 due to the pressure at which the material 21 is applied. This causes compression of the air (or other fluid) in the gap or discontinuity 13. After the material 21 has been applied, the bladder is inflated to a pressure of about 1 bar, which further presses the material into the gap or discontinuity 13—resulting in further compression the air (or other fluid). This can result in air bubbles forming in the material 21. It is desirable to avoid air bubbles in the exterior surface to the material 21. To reduce formation of air bubbles in the exterior surface to the material 21 it is advantageous to periodically vary or pulse the inflation pressure of the bladder after it is initially inflated to 1 bar. This pulsing of the pressure applied to the filling material 21 tends to move any air bubbles away from its exterior surface.

The method of application of gap spanning material 21, as described in relation to FIG. 4 or FIG. 5, may be applied when the pipeline is “live”, i.e. fluid is flowing through the pipeline in substantially the normal manner. If the bladder arrangement of FIG. 5 is to be used in a “live” pipeline, a central fluid passage (not shown) is provided through the bladder to allow fluid to pass through the bladder. The bladder 85 will therefore have an annular shape when inflated.

It should be understood that the gap spanning material 21 may be applied by other methods.

After formation of the filling material 21, a lining material 29 if required may additionally be spray-coated onto the interior surfaces of the pipe sections 1 and 3, and also by virtue of its position, onto the interior surface of the filling material 21. The lining material 29 preferably forms a cross-linked molecular structure to provide an internal fluid-tight coating to the interior of the pipeline. The lining material 29 may comprise Copon Hycote 169 SL or 169 XS, which is a flexible polyurea which is specifically formulated to act as an intercalary layer of protection for new and existing pipelines in the event that holes or cracks appear. Such a lining material is typically applied to a thickness of between 1 mm and 6 mm in a single pass, although subsequent additional passes may be performed, depending on the circumstances. Of course, any other suitable sprayable lining material could be used. FIG. 6 shows the cured lining material 31 forming a continuous fluid-tight coating on the interior surface of the pipe section 1. The lining material 29 may be applied by a vehicle 23 in a similar manner to the filling material 21 in FIG. 4, or a different vehicle may be employed. It should be understood that the lining material 29 may be applied by any suitable spray coating method. As the vehicle 23 passes through the pipeline, the cured lining material 31 forms a continuous fluid-tight coating on the interior surfaces of the pipe sections 1 and 3 and the interior surface 33 of the filling material 21.

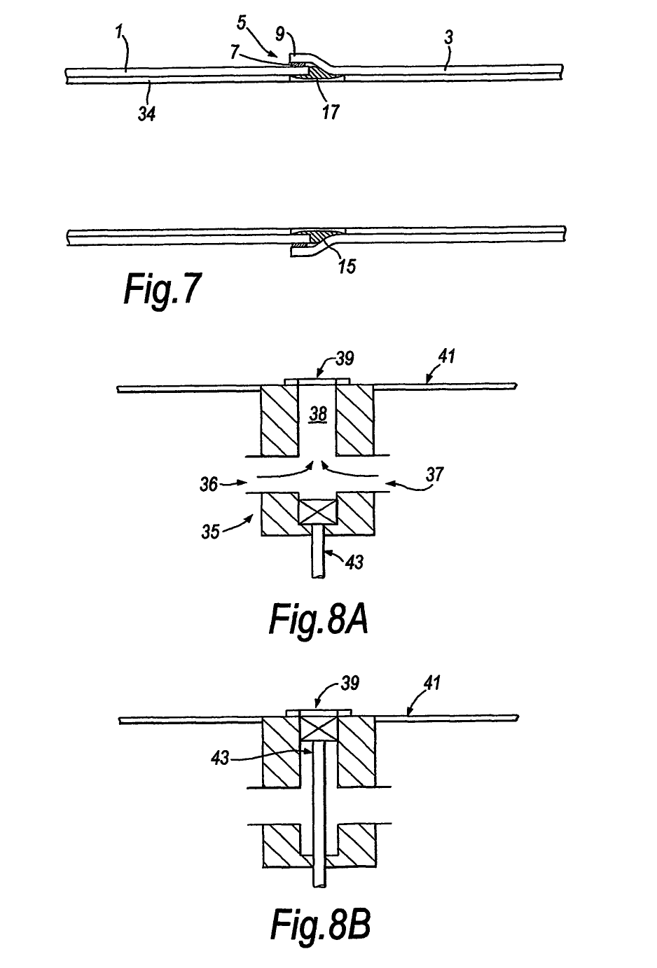

It can be seen from FIG. 7 that the gap spanning material provides a substantially smooth, planar surface, which bridges the gap or discontinuity 13 between the pipe sections I and 3, which is substantially flush with the internal surface of the pipe sections 1 and 3. This allows the successful application of the lining material 29 to form a fluid-tight liner 34.

The gap spanning material 21 may be formed by mixing together two or more components in situ. For example, the gap spanning material 21 may be supplied as two separate components which will remain almost permanently in liquid form in isolation.

However, when the two components are mixed together they will react with one another to set or cure within a fairly short time (for example 1 to 5 minutes). Typically the two components will be different polymers, or one component may be water.

Because, when mixed, the two polymers will cure within a fairly short period of time, the mixing together of the two polymers must occur shortly before the gap spanning material is to be applied to the gap or discontinuity 13 in the pipeline. In order to achieve this, the two polymers must be mixed near the location of the gap or discontinuity. The conventional method of mixing the two polymers is to force them through a static mixer. A disadvantage of this conventional approach is that, when a gap or discontinuity 13 has been filed, the material will set in the static mixer. The static mixer, and the associated apparatus for applying the gap spanning material 21 must then be removed from the pipe after each gap or discontinuity 13 is filled for the static mixer to be cleaned to remove the material set in the static mixer.

FIGS. 8A and 8B show an alternative apparatus and method of mixing two polymers (or other suitable material) to fill a gap or discontinuity 13. In accordance with the embodiment of the present invention. The mixing apparatus 35 may be housed within a suitable device of bringing the mixing apparatus 35 into position for applying gap spanning material 21. Such a device or “packer” may comprise a bladder of the type shown in FIG. 5. However the bladder of FIG. 5 would require modification to require two conduits 93—one for each of the two components of the gap spanning material 21.

The mixing apparatus 35 comprises a first inlet 36 for a first component of the gap spanning material and a second inlet 37 for supplying a second component of the gap spanning material. These components of gap spanning material may be provided from respective reservoirs or conduits. When it is desired to mix the two components of gap spanning material, these components are supplied in liquid form under pressure and at sufficient flow rate to the inlets 36 and 37. Inlets 36 and 37 face one another and the incoming components mix with each other by impingement as they are forced up the channel 38 and subsequently through small orifice 39 to the region on the interior surface of the pipe where a gap or discontinuity 13 is present Orifice 39 is positioned at the surface of 41 of the packer or bladder.

The mixing apparatus 35 comprises a piston 43 reciprocable within the channel 38. When it is desired to apply gap spanning material 21 the piston 43 is maintained in its rest position at the base of the channel in a position away from the outlets 36 and 37, and the channel 38—in the position shown in FIG. 8A. When the gap spanning material has been applied to the gap or discontinuity 13, the piston is moved lineally along the channel until the crown of the piston abuts the orifice 39 (FIG. 8B). Movement of the piston 43 within the channel 38 squeezes any residual gap spanning material in the channel 38 out through the orifice 39. The material ejected in this manner from the orifice 39 is used to complete application of the gap spanning material 21 to the gap or discontinuity 13. The piston 43 is then returned to its rest position shown in FIG. 8A. The movement of the piston 43 to the position shown in FIG. 8B clears the channel 38 of any residual gap spanning material, which would otherwise set or cure within the channel 38, and would require removal of the packer or bladder to clean channel 38. Piston 43 shown in FIGS. 8A and 8B therefore overcomes the disadvantageous requirement for removal of the gap or packer after each gap or discontinuity 13 is filled by automatically removing any residual material from the channel 38 before that material is able to set. The piston 43 may be moved by any suitable means, such as hydraulic or compressed air actuators.

In known conventional gap spanning arrangements the gap spanning material is of the same consistency as water, and is in fact typically 50% water, and consequently such materials do not require mixing prior to application to the gap or discontinuity. They simply mix in the gap or discontinuity and any overspill into the pipe is washed away.

According to an aspect of the present invention, a new polymer is provided which is relatively low in viscosity, can be mixed with water in a variety of ratios, for example 1:1 with a setting time of approximately one minute or less. It is advantageous for the gap spanning material to set within a fairly short period of time as this increases the rate at which a gap or discontinuity can be repaired.

The filling material is advantageously a liquid two-part resin system which sets substantially within one minute of application to the gap or discontinuity, at which point the two parts are mixed. The first part of the resin system comprises polyisocyanate, optionally blended with a non-reactive plasticiser. The second part of the resin system comprises one or more polyamines, optionally blended with one or more polyhydric alcohols (polyols) and/or a non-reactive plasticiser.

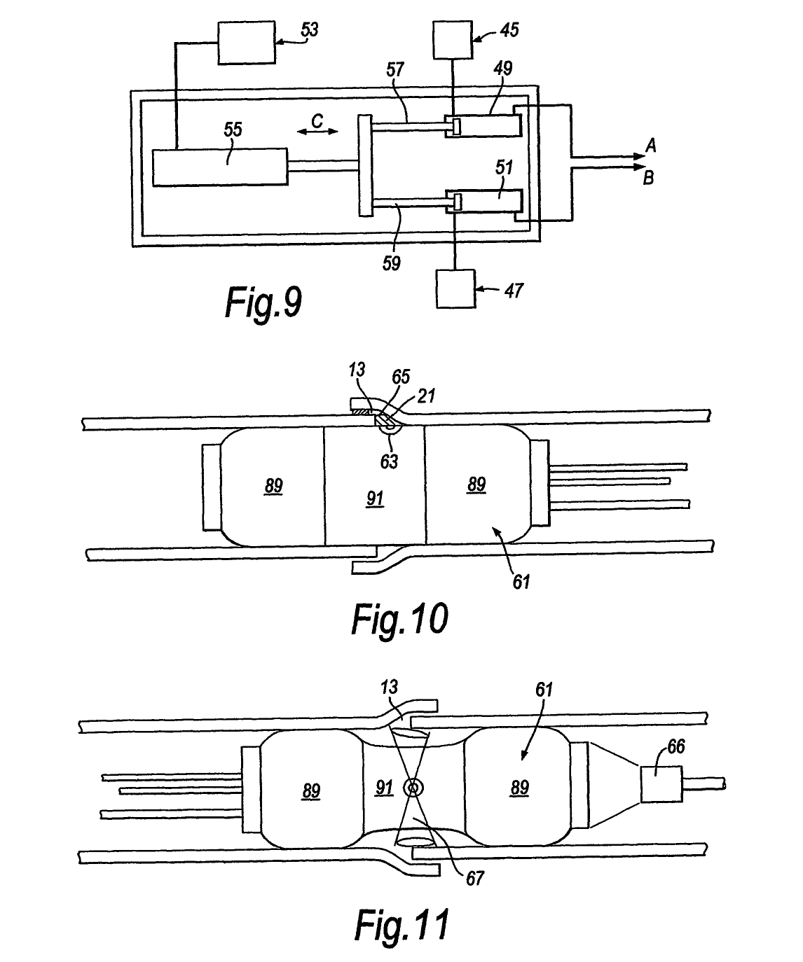

According to another embodiment of the invention, a “triple piston” arrangement is provided for allowing the controlled and metered, high pressure application of gap spanning material to a gap or discontinuity. Referring to FIG. 9, a first reservoir 45 stores a first component of the gap spanning material and a second reservoir 47 stores a second component of the gap spanning material. The reservoirs 45 and 47 supply respective cylinders 49 and 51 with the relevant component of the gap spanning material. The gap spanning material is ejected from cylinders 49 and 51 from an outlet of each cylinder 49 and 51, as indicated by arrows A and B, and these components are subsequently mixed to form the gap spanning material for filling a gap or discontinuity 13. A power pack 53 provides air or hydraulic fluid under pressure to a hydraulic actuator 55 which is mechanically coupled to pistons 57 and 59. Piston 57 is arranged for reciprocal movement within cylinder 49, and piston 59 is arranged for reciprocal movement within cylinder 51. Movement caused by the hydraulic actuator (as indicated by arrow C causes the movement of both pistons 57 and 59 within the respective cylinders 49 and 51, by virtue of the mechanical coupling between the hydraulic actuator and both the piston 57 and piston 59.

When it is desired to provide gap spanning material, hydraulic power pack 53 is actuated and air or hydraulic fluid is pumped into hydraulic actuator 55 causing the pistons 57 and 59 to move simultaneously within the cylinders 49 and 51. The movement of the pistons 57 and 59 reduces the volume available for the component of the gap spanning material in each of the cylinders 49 and 51, and this causes the component to be expelled from the outlet of each of the cylinders 49 and 51 in correct ratios, after which they are mixed together and applied to a gap or discontinuity 13. When sufficient gap spanning material has been applied, the hydraulic power pack 53 moves the hydraulic actuator 55 in the opposite direction, in which in turn causes a reversal of the linear movement of the pistons 57 and 59, thereby allowing the cylinders 49 and 51 to be refilled with relevant component of the gap spanning material from the respective reservoirs 45 and 47. The apparatus shown in FIG. 9 can deliver controlled amounts of gap spanning material at pressures up to and above 2000 psi in approximately eight second bursts. The arrangement in FIG. 9 is designed to deliver metered volumes of the filling or sealing material at sufficient pressures and flow rates to impinge mix the components.

FIG. 10 shows a further embodiment to the invention. A packer 61 (which may be similar to the bladder 85 of the FIG. 5 embodiment may, like the FIG. 5 embodiment, comprise relatively rigid sections 89 and a gap spanning application region 91. When the packer 61 is inflated, the relatively rigid sections 89 press against the interior surface of the pipeline. Gap spanning material 21 is then applied to the region 91. The relatively rigid sections 89 prevent the gap spanning material escaping from the region 91. The gap spanning material 21 is pumped under pressure into this space or discontinuity 13 through a conduit and outlet in the region 91 (not shown).

In accordance with an aspect of the present invention, it is envisaged that there will be no fluid passage between the interior of the pipeline and the exterior of the pipeline. That is, although a discontinuity or gap 13 may be present, there is still no fluid path between the interior and exterior of the pipeline. Performing gap spanning in such circumstances has been found to be problematic. As the gap spanning material 21 is pumped into the space 13 air 65 (or other gas or fluid) already present in the space 13 prior to the pumping into that space is trapped under pressure. The trapped air 65 cannot escape to the exterior of the pipe because there is no fluid passage to the exterior of the fluid pipe. The trapped air 65 cannot also escape past the relatively rigid section 89 as these press fluid-tightly against the interior of the pipe. The presence of the trapped air 65 will then resist the passage of gap spanning material 21 into the gap 13, and may also result in the cured gap spanning material 21 having an uneven finish because, for example, it contains air bubbles.

In accordance with FIG. 10 embodiment of the invention, a port 63 is provided in the wall of the region 91 which allows trapped air 65 to escape from the gap 13 into the packer 61, from where this trapped air 65 can be discharged. The port 63 may be positioned adjacent to the conduit which feeds the gap spanning material 21 into the gap 13.

Advantageously the port 63 may include a membrane or some other means which allows the trapped air 65 to pass therethrough, but does not allow gap spanning material 21 to pass therethrough. For example, the membrane at the port 63 may allow the passage of gas therethrough but may not allow the passage of liquid therethrough. This is advantageous because it prevents the gap spanning material from passing through the port 63, where it would be wasted.

The port is preferably made from a PTFE fabric membrane which allows air particles therethrough but not liquid particles.

Because the trapped air is allowed to escape, the gap spanning material 21 is formed with a substantially smooth surface and without air bubbles.

FIG. 11 shows how the packer 61 is positioned correctly with respect to the gap or discontinuity 13, in order to allow the gap spanning material 21 to be applied correctly and efficiently. In a known conventional method a remote in-line camera 66 is positioned in front of the packer 61. However, because of the position of the camera 66 in front of the packer 61, the packer cannot be easily positioned with respect to the gap or discontinuity 13 because this cannot be seen from the image that is taken by the camera 66. In accordance with an embodiment of the invention, the remote in-line camera 66 may be supplemented by a relatively small camera (for example a mini camera of 12 mm diameter or less) which is positioned in the packer 61 in the region 91 so that, when the region 91 of the packer 61 is correctly aligned with the gap or discontinuity 13, the camera 67 is oriented radially towards the wall of the pipe so that the view captured is that of the gap or discontinuity 13. Images captured by the camera 67 are fed back to the controller. This information can be used to move the packer 61 so that it can be correctly positioned.

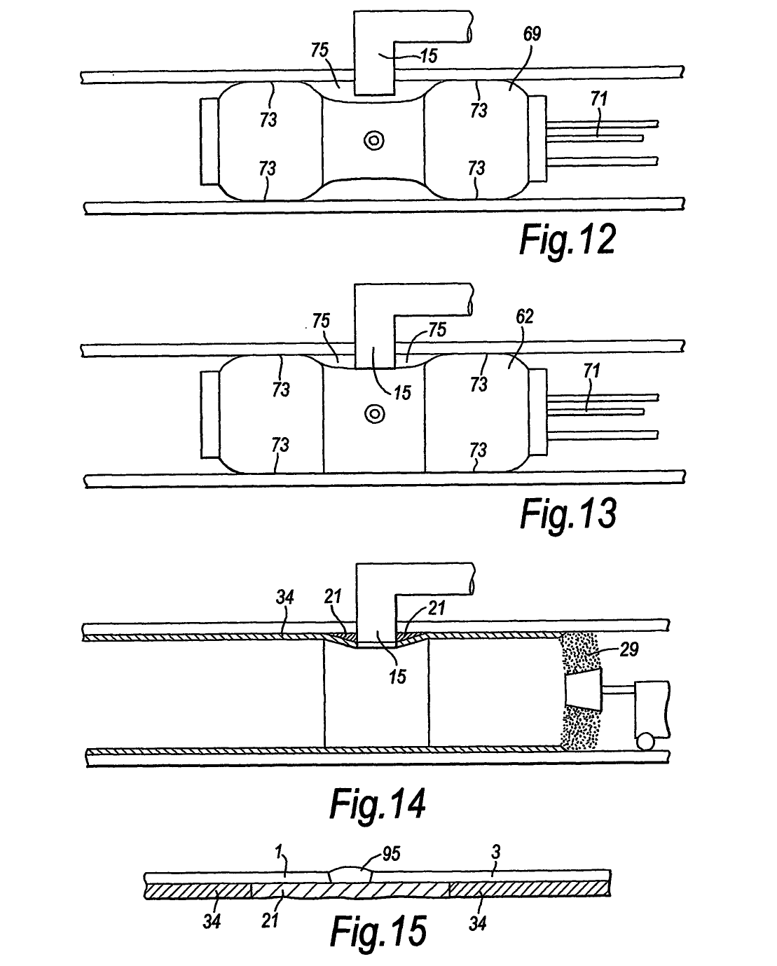

FIGS. 12 to 14 show an alternative method for applying filling or sealing material 21 to the gap or discontinuity in the pipeline. In the example given the discontinuity is a ferrule intrusion 15. In this alternative method, an inflatable bladder 69 is moved, in a state of deflation, to the desired region of the pipeline where the ferrule intrusion 15 is located. The bladder 69 is then inflated by applying fluid pressure via the conduit 71. Generally, the bladder 69 is formed of flexible material. However, relatively rigid sections 73 are provided for location either side of the ferrule intrusion 15, thereby defining a filling material application region 75 around the ferrule intrusion 15.

When the bladder 69 of FIG. 12 is fully inflated, as shown in FIG. 13, the centre section 72 seals against the open end of the ferrule, and the relatively rigid sections 73 press against the interior surface of the pipeline. The filling material 21 can then by applied to the application region 75. The relatively rigid sections 73 prevent the filling material 21 escaping from the application region 75. The bladder 69 may remain in position after application of the filling material 21 in order to allow the material to cure, if necessary. This method allows the filling material 21 to fill the void around the ferrule intrusion thus creating a smooth contour, and may additionally provide a means of sealing any leakage path in the threaded portion of the ferrule intrusion.

The smooth contour of filling material 21 formed around the ferrule intrusion 15 as described by the method of FIGS. 12 and 13 creates a substantially continuous surface for a subsequently sprayed lining material 34 if this is required, as shown in FIG. 14. Compared to the prior art shown in FIG. 3 it can be seen that this method avoids the unwanted “spray shadow” area 19, instead allowing the application of a substantially uniform layer of lining material 34. A uniform liner thickness is advantageous because it will have long-term strength.

FIG. 15 shows a first pipe section 1 and a second pipe section 3 connected together by a weld 95. These pipe sections are pre-lined with respective liners 34 prior to welding them together. However, the liner 34 is not provided in the region of weld because the heat generated by the welding process would melt or otherwise damage the liner. The discontinuity in the liner at the region of the weld is disadvantageous because it results in an uneven surface of the interior of the pipe and because the weld may be damaged by or may contaminate the fluid contained in the pipe. After the weld 95 has been formed, gap spanning material 21 is applied to bridge the gap in the liner 34. The gap spanning material 21 may comprise the same material as the liner 34.

The gap spanning method described may also be employed in bridging cracks or holes (for example, due to corrosion) formed in a pipeline, whether or not such a pipeline comprises a plurality of discrete sections. The gap spanning method may also be employed to seal off a fluid passage communicating with the main pipeline, where that fluid passage has become redundant.

1. A method of treating a pipe having at least one gap on an interior surface thereof, the method including the step of applying filling material to the gap so as to provide a generally smooth interior surface of filling material that is substantially flush with the interior surface of the pipe at a region of the gap, or and the subsequent step of applying a lining material over the interior surface of the pipe and the filling material to form a continuous fluid-tight coating of the pipe.

2. (canceled)

3. A method according to claim 1, wherein the gap is created by deterioration of the pipe over time.

4. A method according to claim 1, wherein the gap is a redundant fluid passage.

5. A method according to claim 1, wherein the gap of is a protrusion from the interior surface of the pipe.

6. A method according to claim 1, wherein the filling material is applied such that it bridges across the gap of but does not completely fill the gap or discontinuity.

7. A method of forming a pipe including coupling a plurality of pipe sections, such that there is at least one or discontinuity on the interior surface thereof applying filling material to the gap so as to provide a generally smooth interior surface of filling material that is substantially flush with the interior surface of the pipe at a region of the gap, and the subsequent step of applying a lining material over the interior surface of the pipe and the filling material to form a continuous fluid-tight coating of the pipe.

8. A method according to claim 7, wherein the pipe sections are coupled by a spigot and socket joint.

9. A method according to claim 7, wherein the pipe sections are coupled by a welded joint.

10. A method according to claim 7, wherein the pipe sections are coupled a bolted gland joint.

11. (canceled)

12. A method according to claim 7, wherein a fluid seal is applied between the pipe sections.

13. A method according to claim 12, wherein the fluid seal is applied prior to applying the filling material.

14. A method according to claim 12, wherein the fluid seal is located further from centre of the pipe than the filling material.

15. A method according to claim 1, wherein the filling material is applied by spraying the filling material onto the interior surface of the pipe.

16-17. (canceled)

18. A method according to claim 1, wherein the filling material is applied by forming a cavity at the gap or and supplying filling material to the cavity.

19. A method according to claim 18, wherein the cavity is formed by an inflatable bladder inflated within the pipe.

20. A method according to claim 1, wherein the lining material is applied by spraying.

21. A method according to claim 1, wherein the lining material forms a cross-linked molecular structure.

22. A method according to claim 1, wherein the lining material is a flexible polyurea.

23. A method according to claim 12, wherein the fluid seal is applied prior to lining the pipeline.

24. A method according to claim 12, wherein the fluid seal is applied after lining the pipeline.

25. A method according to claim 1, wherein the filling material is a liquid, two-part resin system which sets substantially within one minute of the two parts mixing.

26. A method according to claim 25, wherein a first part of the resin system comprises material selected from the group consisting of polyisocyanate and polyisocyanate , optionally blended with a non-reactive plasticiser.

27. A method according to claim 25 , wherein a second part of the resin system comprises a material selected from the group consisting of a polyamine, a Plurality of polyamines, a polyamine blended with a polyhydric alcohol, a polyamine blended with a non-reactive plasticiser, polyhydric alcohol and a non-reactive plasticiser.

28. A method according to any one of the preceding claim 1, wherein the filling material comprises two components which set when combined, the method including combining the two components in a channel from which the combined components pass to the gap or discontinuity and further including removing residue of said components from said channel after treating the gap of with the filling material.

29. A method according to claim 28, wherein the residue is removed by a piston moving in said channel.

30. A method according to claim 29, wherein the residue removed by the piston completes the application of the filling material to the gap or discontinuity.

31. A method according to claims 1, wherein the filling material comprises a plurality of components, each stored in respective reservoirs and wherein the components are ejected from said reservoirs simultaneously.

32. A method according to claim 31, wherein the components are ejected from said reservoirs by movement of a piston in each of said reservoirs.

33. A method according to claim 32, wherein the respective pistons in each reservoir are coupled to one another and are moved by a common power source.

34. (canceled)

35. A method according to claim 18, wherein gas trapped in said cavity released or compressed as said filler material is applied to the gap or discontinuity.

36. A method according to claim 35, wherein the gas is released through port means in said cavity.

37. A method according to claim 36, wherein the port means allows the passage therethrough of gas but not liquid.

38. A method according to claim 37, wherein the port means comprises a PTFE fabric membrane which allows air particles therethrough but not liquid particles.

39. A method according to claim 18, including using information obtained from a camera in said cavity to locate the cavity with respect to the gap or discontinuity.

40. (canceled)

41. Apparatus for lining a pipe having at least one gap in an interior surface thereof, the apparatus including means for applying filling material to the gap or discontinuity such that a generally smooth interior surface of filling material that is substantially flush with the interior surface of the pipe is formed at region of the gap and by means for subsequently spraying a liner material over a region of the interior surface including the filling material to form a continuous fluid-tight coating of the pipe.

42. The apparatus according to claim 41, wherein the said applying means is operable to apply a low viscosity polymer.

43. Apparatus for lining a pipe having at least one gap therein, the apparatus including means for applying filling material to the gap so as to form a generally smooth interior surface of the pipe at the region of the gap or discontinuity the applying means comprising a source of a first component of the filling material and a source of a second component of the filling material a channel coupled to the respective sources for receiving the first and second components therefrom and in which the first and second components to cause the components to set, and a means for removing residue of said components from the said channel after application of the filling material to the gap or discontinuity.

44. The apparatus of claim 45, wherein the removing means comprises a piston reciprocatable within the channel.

45. Apparatus for lining a pipe having at least one gap in an interior surface thereof, the apparatus comprising means for applying filling material to the gap so that a generally smooth interior surface of the pipe is formed at the region of the gap a plurality of reservoirs in which respective components of the filling material are stored, and means for ejecting the components from the respective reservoirs simultaneously in order to apply the filling material.

46. The apparatus of claim 45, wherein the ejecting means comprises a reciprocatable piston of each of said reservoirs for urging the components stored therein to be ejected in metered quantities through an outlet of each of the reservoirs for application to the gap or discontinuity.

47. The apparatus of claim 46, including means for coupling together the pistons in the respective reservoirs, a power sources, and coupling means for applying power from the said power source to each of the pistons.

48. (canceled)

49. The apparatus of claim 5, wherein the filling material is delivered at a pressure of substantially 2000 PSI or above.

50.-51. (canceled)
